(19) United States
(12) Patent Application Publication
(10) Pub. No.: US 2023/0273807 A1
(43) Pub. Date: Aug. 31, 2023

(54) POWER OPTIMIZATION BASED ON WORKLOAD PLACEMENT IN A CLOUD COMPUTING ENVIRONMENT

(71) Applicant: VMWARE, INC., Palo Alto, CA (US)

(72) Inventors: VENU MAHESH UPPALAPATI, Bangalore (IN); Sairam Veeraswamy, Coimbatore (IN); Adarsh Jagadeeshwaran, Bangalore (IN); Shalini Singh, Bangalore (IN)

(21) Appl. No.: 17/731,290

(22) Filed: Apr. 28, 2022

(30) Foreign Application Priority Data
Jan. 21, 2022 (IN) 202241003662

(51) Int. Cl. G06F 9/455; G06F 1/3206

(52) U.S. Cl. CPC G06F 9/45558; G06F 1/3206; G06F 9/45545; G06F 2009/4557

(57) ABSTRACT

A power optimization system may include a cloud management server coupled to a plurality of clusters via a network, a resource management module residing in the cloud management server, and a cloud power optimizer module residing in the resource management module. Each cluster may include a plurality of physical hosts with at least one virtual machine (VM) running on each physical host. During operation, the cloud power optimizer module may determine background and active power usages of each physical host in the plurality of clusters. Further, the cloud power optimizer module may determine power usage of each VM based on the determined background and active power usages of each physical host. Furthermore, the cloud power optimizer module may continuously balance a distribution of workload on the plurality of physical hosts based on the determined power usage of each VM.

### RELATED APPLICATION

Benefit is claimed under 35 U.S.C. 119(a)-(d) to Foreign Application Serial No. 202241003662 filed in India entitled “POWER OPTIMIZATION BASED ON WORKLOAD PLACEMENT IN A CLOUD COMPUTING ENVIRONMENT”, on Jan. 21, 2022, by VMware, Inc., which is herein incorporated in its entirety by reference for all purposes.

### TECHNICAL FIELD

The present disclosure relates to power optimization in a cloud computing environment, and more particularly to methods, techniques, and systems for power optimization based on balancing workload distribution in a cloud computing environment.

### BACKGROUND

Over the years, with the technical advancements in resource management platforms, advent of smart devices, and resources becoming faster and less expensive, customers are trying to increase their workload consolidation ratios in datacenters. This may result in a significant number of workloads running together on bigger and faster servers, possibly with the assistance of smart devices, such as, Persistent Memory (PMEM), Quick Assist Technology (QAT), Graphics Processing Units (GPUs), and so on.

In many cases, enterprises prioritize workloads based on performance and Total Cost of Operations (TCO) for their tenants over datacenter power usage. This may be because such enterprises are not incentivized to achieve sustainable power usage. Another factor may be that many enterprises are using some form of cloud (private or public). In the cloud scenario, enterprises generally pay for the power costs indirectly, because they are not running on their own hardware and/or datacenters and hence may not consider power costs of their workloads or may account for the costs using a different cost structure (e.g., Infrastructure as a Service).

Generally, resource management platforms are optimized for managing the resource demands of workloads (e.g., virtual machines (VMs)) by ensuring that they have enough computing, networking, and storage resources, to ensure that the performance of these workloads does not suffer due to lack of such resources. The power usage of the servers running these workloads is frequently not considered in resource management platforms. It may also be non-trivial to map the workloads and their resource consumption to the power consumed due to these workloads by an underlying physical layer. Thus, the above-mentioned aspects may be overlooked for the datacenter power management.

### BRIEF DESCRIPTION OF THE DRAWINGS

FIG. 1 is a block diagram of an example power optimization system;

FIG. 2 is a flowchart illustrating an example method for power optimization based on a distribution of workload on physical hosts in a cloud computing environment; and

FIG. 3 is a block diagram of an example computing device including non-transitory machine-readable storage medium storing instructions to cause power optimization based on a distribution of workload on physical hosts in a cloud computing environment.

The drawings described herein are for illustration purposes only and are not intended to limit the scope of the present subject matter in any way.

### DETAILED DESCRIPTION

The paragraphs [009] to [0012] describe about how, generally, resource management platforms are used to prioritize workloads based on performance over power usage in the datacenters. With the advancements in cloud computing, enterprises may have adopted a hybrid cloud model with a significant number of workloads running in some form of cloud (private or public). Typically, in such cloud models, enterprises may indirectly pay for the power costs and hence may not consider power costs of their workloads or may account for the costs using a different cost structure (e.g., Infrastructure as a Service).

Generally, resource management platforms are optimized for managing the resource demands of workloads by ensuring that they have enough compute, networking, and storage resources to ensure that the performance of these workloads do not suffer due to lack of such resources. The power usage of the servers running these workloads is frequently not considered in resource management platforms. It may also be non-trivial to map the workloads and their resource consumption to the power consumed due to these workloads by an underlying physical layer. As a result, the above-mentioned aspects may be overlooked for the datacenter power management.

Furthermore, growth in cloud computing and datacenters may cause significant environmental problems, such as atmospheric carbon emissions resulting from an increased power consumption of servers, storages, networking equipment, and cooling systems as growing amounts of data are being processed. In addition, many corporations have implemented social responsibility goals that necessitate reducing their environmental footprint, which ensures compliance with such goals.

There are many ways in which the enterprises can achieve a significant value by optimizing power consumption in their datacenters. By doing so, the enterprises can not only reduce their operational costs, but they can also achieve sustainability targets in their datacenter operations. Optimizing power consumption in this context is not limited to accounting and reducing the Central Processing Unit (CPU) GHz consumed by the servers or the power in “Watts per hour” consumed by the cooling equipment in the datacenters. There are many factors to be considered in overall power management, such as engineering processes (e.g., product build, test, continuous integration/continuous delivery (CI/CD) pipeline, etc.). Another important aspect is the area of workload management, which is the realm of Chief Information Officers (CIOs) and datacenter administrators. Typically, resource management platforms, such as vSphere Distributed Resource Scheduler (DRS), assist administrators to ensure that the servers are utilized in an efficient manner and that the workloads running on the servers do not face resource contention.

In the following paragraphs, details are set forth that layout several factors that can provide more insight and can potentially aid resource management engines to better manage the overall power consumption in the datacenters, while also managing the workloads in the cloud. Further, the following paragraphs describe physical host power usage and VM power usage-based workload placement (i.e., based on physical host and VM power profile) to ensure that the demanding workloads are scheduled to physical hosts with the highest compute per watt and power efficiency capabilities. In addition, a new power goodness metric at a physical host level for scoring a current power supply efficiency and thermal hotspot locality impacts are used in further improving the workload placements. Also, power performance balanced workload placements by integration with existing performance-based workload placement algorithms are used in achieving the power efficiency capabilities.

The terms “workloads” and “VMs” are used interchangeably throughout the document. In addition, the terms “server” and “physical hosts” are used interchangeably throughout the document. Also, the terms “datacenter” and “cloud” are used interchangeably throughout the document. Further, the terms “resource management platform”, “resource management engine”, and “resource management module” are all used interchangeably throughout the document. In this document, the term “power” also refers to “energy”.

In the following description, for purposes of explanation, numerous specific details are set forth to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

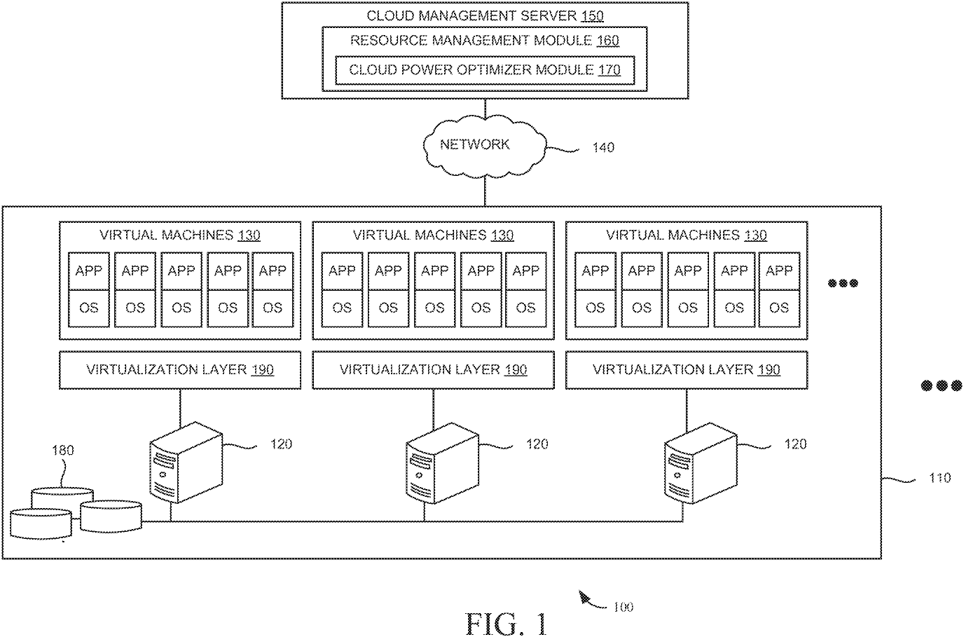

Turning now to the figures, FIG. 1 is a block diagram of an example power optimization system 100. Example power optimization system 100 may be a virtualized computing environment (VCI) or a cloud computing environment. Further, example power optimization system 100 may include a virtual datacenter. The virtual datacenter may be a pool or collection of cloud infrastructure resources designed for enterprise needs. Furthermore, the virtual datacenter may be a virtual representation of a physical datacenter, complete with servers, storage clusters, and networking components, all of which may reside in a virtual space being hosted by one or more physical datacenters. Also, each datacenter may include multiple host computers (i.e., physical hosts 120).

As shown in FIG. 1, power optimization system 100 may include a plurality of clusters 110. Further, as shown in FIG. 1, each cluster may include a plurality of physical hosts 120. The physical host may be a hardware-based device (e.g., a personal computer, a laptop, and the like) including an operating system (OS). Furthermore, as shown in FIG. 1, at least one virtual machine (VM) 130 may be running on each physical host. For example, each VM may operate with its own guest OS on the physical host virtualized by a virtualization layer 190 (e.g., a hypervisor). Further, each VM 130 may execute different types of applications (APPs).

In addition, as shown in FIG. 1, power optimization system 100 may include a cloud management server 150 communicatively connected to the plurality of clusters 110 via a network 140. Example network can be a managed Internet protocol (IP) network administered by a service provider. For example, the network140 may be implemented using wireless protocols and technologies, such as Wi-Fi, WiMAX, and the like. In other examples, the network 140 can also be a packet-switched network, such as a local area network (LAN) wide area network (WAN), metropolitan area network (MAN), Internet network, or other similar type of network environment. In yet other examples, the network 140 may be a fixed wireless network, a wireless LAN, a wireless WAN, a personal area network (PAN), Intranet or other suitable network system and includes equipment for receiving and transmitting signals. Also, as shown in FIG. 1, cloud management server 150 may include a resource management module 160. Further, the resource management module 160 may include a cloud power optimizer module 170.

Example cloud management server 150 may manage different objects/resources in the virtualized computing environment. For example, cloud management server 150 may execute centralized management services that may be interconnected to manage the resources centrally in the virtualized computing environment. Example centralized management service may be a part of vCenter Server™ and vSphere® program products, such as resource management module which are commercially available from VMware. Example resource management module 160 may be part of a Distributed Resource Scheduler™ (DRS), which is a resource scheduling and load balancing solution for vSphere. DRS works on the plurality of physical hosts 120, such as, ESXi hosts and provides resource management capabilities like load balancing and virtual machine (VM) placement.

During operation, the cloud power optimizer module 170 determines background and active power usages of each physical host in the plurality of physical hosts 120 in the plurality of clusters 110. Example background power usage may be the power used by a physical host 120 when there are no workloads running on the physical host 120. Active power usage may be an increased power usage by the physical host 120 when the workloads are running in the physical host 120. In an example, the cloud power optimizer module 170 determines background and active power usages of a physical host and its sub-systems, such as CPU and memory. In another example, the cloud power optimizer module 170 determines background power usage of each physical host using a minimum power usage metric from the host sub-systems. Example minimum power usage metric may be based on minimum power used by a physical host since the physical host was placed in operation. Typically, CPUs and graphical processing units (GPUs) are a source of power consumption. For example, CPU and GPU vendors provide power usage statistics, which may be used for further computation of background and active power usages of each physical host.

The cloud power optimizer module 170 determines power usage of each VM running on each physical host in the plurality of clusters 110 based on the determined background and active power usages associated with the physical host in the plurality of physical hosts 120. In one example, the cloud power optimizer module 170 divvies the active physical host power usage amongst the plurality of VMs 130 running on a physical host. In an example, different VMs 130 running on one or a plurality of physical hosts 120 have different power usage requirement and consumption. In one example, the power usage of each VM may be estimated based on resource utilization metrics of sub-systems in the VMs, such as, CPU, GPU, memory and/or disk. In an example, the cloud power optimizer module 170 determines the active power usage of a physical host in the plurality of physical hosts 120 based on the background energy usage, utilization statistics at VM level of sub-systems, and/or power usage requirement of each VM. Example sub-systems are GPU, CPU memory, and/or field programmable gate array (FPGA).

In another example, the cloud power optimizer module 170 obtains power profiles of the plurality of physical hosts 120 based on the type(s) of physical hosts 120 in each cluster. Power profiles may be assigned by an administrator or obtained from server vendors. For example, the type of physical hosts is based on physical host generation (e.g., an older generation server, a newer generation server, or the like), advance power capabilities, and/or compute per watt. In an example, the cloud power optimizer module 170 may organize the plurality of clusters 110 as a spectrum having multiple bands, for example, clusters of physical hosts with an ability to manage power, clusters of physical hosts belonging to a newer generation, clusters of physical hosts which are “power hungry” (in need of power) with limited power management capabilities, or the like. Further, the cloud power optimizer module 170 organizes each cluster based on the obtained power profiles. In another example the cloud power optimizer module 170 may obtain power profiles of each physical and logical sub-systems in each physical host.

Further, the cloud power optimization module 170 obtains the physical location of each physical host in the cloud computing system based on thermal hotspots in the cloud computing system. For example, thermal hotspots may be located inside or in the vicinity of the cloud computing system. In one example, the cloud power optimizer module 170 determines proximity of each physical host to the thermal hotspot based on obtained thermal hotspot locations in the cloud computing environment for workload placement. In another example, the cloud power optimization module 170 obtains thermal hotspot locations in the cloud computing environment based on vendor provided thermal statistics at a rack level power, a row level power, and thermal headroom. In yet another example, the cloud power optimization module 170 determines physical location of each physical host using vendor provided software that identifies and locates thermal hotspots at a rack and room level. In such cases, the software may be integrated into the cloud power optimization module 170. Also, for example, if hotspot proximity of physical hosts (for example, servers) is available, then they may be directly factored in goodness calculations. However, if they are not available, then the hotspot proximity of the physical hosts may be determined based on thermal hotspot data and datacenter physical layout data.

Furthermore, the cloud power optimizer module 170 obtains power profiles of the plurality of physical hosts 120 based on a type of physical hosts 120 in each cluster. Example type of physical hosts 120 may be based on physical hosts belonging to an older generation, physical hosts belonging to a newer generation, physical hosts that are power-hungry with limited power management capability, physical hosts having advanced power management capability and/or compute per watt usage. The cloud power optimizer module 170 may then label the plurality of clusters 110 based on the obtained power profiles. Example labeling may be a power-hungry cluster, an advanced power management capability cluster, and so on. Example VM power usage determination may be based on active power usage and background power usage of a physical host and its subsystems, such as CPU and memory. In one example, the cloud power optimizer module 170 may determine a desired power profile of each VM running in each cluster based on a resource usage. Further, the cloud power optimizer module 170 maps the desired power profile of each VM to one of the labeled plurality of clusters.

Further in operation, the cloud power optimizer module 170 continuously balances the distribution of workload on the plurality of physical hosts 120 based on the determined power usage of each VM. In an example, the cloud power optimizer module 170 continuously balances the distribution of workload on the plurality of physical hosts 120 via migrating one or more VMs or applications between the plurality of physical hosts 120. In one example, the cloud power optimizer module 170 assigns each VM to one of the labelled plurality of clusters 110 based on a desired power profile of each cluster. The cloud power optimizer module 170 then continuously balances the distribution of workload on the plurality of physical hosts 120 based on the mapping. In yet another example, the cloud power optimizer module 170 may utilize physical host and VM power profile to balance the distribution of workload on the plurality of physical hosts 120, thereby ensuring that the demanding workloads are scheduled to servers with highest compute per watt and power efficiency capabilities.

Further, power optimization system 100 may include a plurality of storage systems 180 that are communicatively coupled to the plurality of clusters. Each storage system 180 may include data sets. In this example, the cloud power optimizer module 170 may:
receive a call to balance a data set residing in the plurality of storage systems 180,
determine whether migration of the data set is to be performed to balance hot data, balance the warm data, and/or re-tier the plurality of storage systems to improve storage efficiency, and
migrate the data set from one storage system to another storage system based on a result of determination of whether the migration of the data set is to be performed to balance hot data, balance the warm data, and/or re-tier the plurality of storage systems in combination with the determined power usage, physical location, and/or background power usage of the physical hosts.

Example cloud power optimizer module 170 obtains utility rate structures. The cloud power optimizer module 170 may then continuously balance the distribution of workload on the plurality of physical hosts 120 based on the mapping, the obtained power management policies, and the utility rate structures. Example utility rate structures are time-based tariffs, demand-based tariffs and/or usage-based tariffs.

The cloud power optimizer module 170 may continuously balance the distribution of workload on the plurality of physical hosts 120 such that a power utilization of a physical host is substantially within a high efficiency band of a power supply unit in the physical host. Example high efficiency band may be based on a power supply efficiency curve associated with the power supply unit in the physical host.

In an example, when power usage associated with the plurality of VMs 130 and the plurality of physical hosts 120 are not available, the cloud power optimization modulel70 may balance the distribution of workload on the plurality of physical hosts 120 in the cloud computing environment 100 based on performance and/or a default placement/balancing algorithm.

In one example, the cloud power management module 170 may differentiate instances of a cluster with specific compute, storage, network attributes (e.g., capacity, capability, reliability, data proximity and so on) and organize them into a spectrum with grayscale such that a low end in a scale is a cluster that is low cost, low capacity, and average performance to high end aggregated cluster with modern and advanced generation servers, storage, and accelerators. In another example, the cloud power management module places the VMs on the plurality of physical hosts 120, schedules the placement of the VMs on the plurality of physical hosts 120, or balances the distribution of workload on the plurality of physical hosts 120 based on the power management capabilities of the plurality of clusters 130 in a meta cluster.

In an example, the cloud power optimizer module 170 may balance the distribution of workload on the plurality of physical hosts 120 based on a power efficiency and a physical location of each physical host. In another example, the cloud power optimizer module 170 may balance the distribution of workload on the plurality of physical hosts 170 based on a power efficiency along with a power usage. The cloud power optimizer module 170 may consider physical locations of the plurality of physical hosts 120, when balancing the plurality of physical hosts 120 to avoid formation of thermal hotspots.

As the power usage of a physical host approaches its physical limits, i.e., once it approaches above a higher threshold value, the power efficiency of the physical host may significantly drop, and which may increase cost due to increased power usage. Power efficiency of a physical host may also drop at a lower band utilization or at a lower threshold value. In an example, a negative cost may be assigned if the power utilization of a physical host goes below the lower threshold value. Similarly, a negative cost may be assigned if the power utilization of a physical host goes above the higher threshold value. Also, if a physical host is located inside a thermal hotspot, the cost associated with power usage may go up significantly. Following example equation may be used in computing the costs associated with power usage and a physical location of a physical host:

$${\text{Cost}}_{\text{P}} = \left(\text{k} / \left({\text{PS}}_{\text{score}} {\text{* CW}}_{\text{eff}}\right) \text{*} \left(exp \left(\text{2, THPF}\right)\right)\right)$$

Where k is a constant to be tuned based on experimental runs, CWeff = server compute per watt efficiency, which may be based on static measurements, PS_{score} = (PSUefficiency(_{Estimated} _{Utilization})) / (Low utilization factor), Estimated Utilization = current server power utilization + estimated VM power utilization, low utilization factor = At 50% utilization and below, a negative multiplier is included (e.g., value is 1 at >50% utilization). PS_{score} refers to a computed power supply operating efficiency score that is based on whether a physical host is feasible for power optimization or not. PSU refers to the power supply unit of a server. In one example, the power goodness score at a physical host level may be used to score a current power supply efficiency in computing the costs.

Example assigned THPF (thermal hotspot proximity factor) may be ‘0’ if a physical host is outside the hotspot, ‘1’ if the physical host is in the periphery of the hotspot, and ‘2’ if the physical host is inside the hotspot.

For example, if the physical host is a registered host for the VM, the cost calculation may be slightly modified at below 75 percent utilization. If by migrating a workload, i.e., migrating a VM out of a physical host, the power utilization may drop below 40% or lower bound of the PSU high efficiency band, a negative power cost may then be applied, even though the current power utilization is above 50% in the PSU high efficiency band and so on.

Some example advanced power management awareness and power management capabilities may include allowing power profile specifications, such as balanced and maximum performance, and smarter deep sleeping for CPUs. Power management of CPUs can be an effective technique for managing overall power consumption and hence costs associated with power usage. Generally, modern servers may come with power management modules via software that can be leveraged for resource management engines, such as VMware’s vSphere distributed resource scheduler (DRS). Typically, at a high level, the servers have maximum performance (disable power management features that may affect performance); balanced power and performance (maximize power savings without impact to performance); minimum power usage (keep all power reduction mechanisms even those impacting performance). Generally, the resource management engines can leverage the advanced power management capability and choose and tune custom system power management profile to suit workload requirement. Modern servers can automatically configure basic input output system (BIOS) settings to match power management profiles. At a more granular level, hardware level, and more specifically at CPU level, dynamic voltage, and frequency scaling (DVFS) capability, also called CPU speed scaling or CPU throttling, can be integrated into resource management engines functionality. A CPU speed scaling highest clock frequency may be equated to no power saving and vice versa. These controls are currently at a kernel level and may be utilized by resource management engines.

Typically, data storage is also performed in load balancing framework driven by Distributed Resource Scheduler (DRS). The data is moved from one storage system to another storage system - either within a cluster or across the clusters with a hybrid cloud deployment setup. DRS may take into account the VM data locality, storage performance, cost, availability, and capacity attributes into consideration while choosing a migration target and the speed at which the data is migrated.

Power profile of a target storage may be added into consideration of DRS while selecting the storage target for balancing. Typically, the storage device vendors publish power profiles for their devices. The power profiles of storage devices may be taken into consideration while moving the live hot, warm, and cold data. There are multiple factors that can influence the storage power profile, which may include a server-side power file for accessing the storage, power consumed by fabric elements (including multiple paths, and so on), power profile of the storage elements (logical unit number (LUN), etc.), and power profile of the storage services offered and leveraged by the server-side data management software.

In an example, the cloud power optimizer module 170 may take the end-to-end storage power profile of chosen granular elements (e.g., LUNs, virtual volumes (vVols), and so on) into consideration while taking the decision on the target storage selection for balancing. Following are some examples for balancing storage devices based on power optimization by the cloud power optimizer module 170.

While balancing a workload across a cluster, if the data set being migrated is hot, then the power profile may be given least priority by the cloud power optimizer module 170. However, the cloud power optimizer module 170 may choose low power devices based on priority attributes like capacity, performance, cost, and/or availability. In an example, if the balancing is performed to re-tier the storage to improve the storage efficiency, then the cloud power optimizer module 170 may give priority to storage power profile and may choose the target storage which consumes less power during its steady state operation with minimal or no data access (cold data). In another example, if the balancing is performed to rebalance the warm data, the cloud power optimizer module 170 may consider power at par with rest of the attributes.

The cloud power optimizer module 170 may provide a dashboard mechanism to track the power profile of an end-to-end storage system during steady state (input output (10) and data services) and when deploying data services.

The cloud power optimizer module 170 may perform power-based throttling wherein the storage balancing may be throttled based on available shares of power for a given VM. The power share may be added per VM for sustainability awareness. The power optimizer module 120 may allocate power share to a VM based on server power, fabric power, and storage power profile.

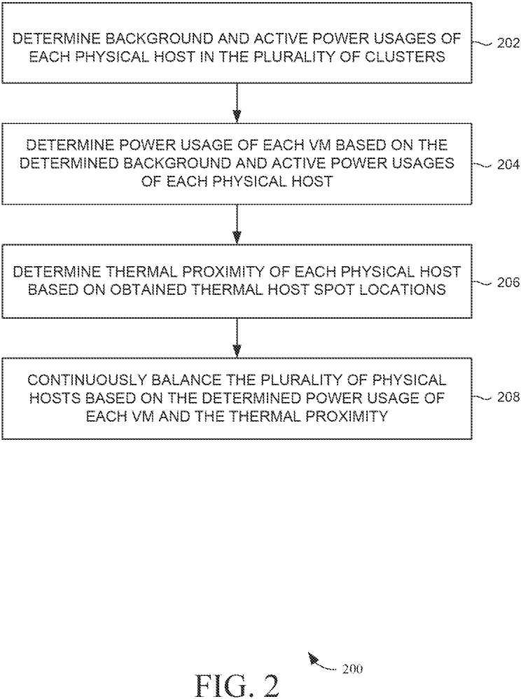

FIG. 2 is a flowchart illustrating an example method 200 for power optimization based on workload placement in a cloud computing environment. At 202, background and active power usages of each physical host in the plurality of clusters are determined. Each cluster may include a plurality of physical hosts with at least one virtual machine (VM) running on each physical host. At 204, power usage of each VM is determined based on the determined background and active power usages of each physical host. In one example, the distribution of workload on the plurality of physical hosts is continuously balanced based on the determined power usage of each VM.

Further, thermal hot spot locations in the cloud computing environment are obtained. At 206, thermal hotspot proximity of each physical host may be determined based on the obtained thermal hot spot locations in the cloud computing environment. At 208, the distribution of workload on a distribution of workload on the plurality of physical hosts is continuously balanced based on the determined power usage of each VM and the determined thermal hotspot proximity of each physical host.

Further, example method 200 may include obtaining power profiles of the plurality of physical hosts based on types of physical hosts in each cluster. For example, the type of physical hosts may be based on older generation, newer generation, power hungry (e.g., real-time power consumption), limited power management capabilities, advance power management capabilities, and/or compute power per watt usage. Each cluster is then labeled based on the obtained power profiles. A desired power profile of each VM running in each physical host in each cluster may be determined based on a resource usage. The determined desired power profile of each VM is then mapped to one of the labeled plurality of clusters. For example, based on the determined desire power profile of each VM, one of the labeled plurality of clusters is then selected for running the VMs. The distribution of workload on the plurality of physical hosts in the plurality of clusters is then continuously balanced based on the mapping.

Furthermore, example method 200 may include obtaining utility rate structures. Example utility rate structures may include utility rate structures based on time-based tariffs, demand-based tariffs and/or usage-based tariffs. The distribution of workload on the plurality of physical hosts running in the cluster may then be continuously balanced based on the mapping and the determined utility rate structures.

In addition, example method 200 may include receiving a call to balance a data set residing in one of a plurality of storage systems that are communicatively coupled to the plurality of clusters in the cloud computing environment. Further, a check is made to determine whether migration of the data set is to be performed to balance hot data, balance the warm data, and/or re-tier the plurality of storage systems to improve storage efficiency. Furthermore, the data set may be migrated from one storage system to another storage system based on a result of determination in combination with the determined power usage, physical location, and/or background power usage of the physical hosts. The data set may then be migrated based on the result of determination.

In one example, the distribution of workload on the plurality of physical hosts is continuously balanced based on performance and/or power profiles of the plurality of clusters.

Also, example method 200 may include obtaining power supply efficiency curve of a power supply unit in each physical host. The distribution of workload on the plurality of physical hosts is then continuously balanced such that a power utilization of a physical host is substantially within a high efficiency band of the power supply unit. For example, the high efficiency band is based on the obtained power supply efficiency curve.

In an example, the method 200 depicted in FIG. 2, may represent generalized illustrations. Other processes may be added, or existing processes may be removed, modified, or rearranged without departing from the scope and spirit of the present application. In addition, the method 200, may represent instructions stored on a computer-readable storage medium that, when executed, may cause a processor to respond, for example, to perform actions, to change states, and/or to make decisions. The method 200, may represent functions and/or actions performed by functionally equivalent circuits like analog circuits, digital signal processing circuits, application specific integrated circuits (ASICs), or other hardware components associated with the system. Furthermore, method 200, is not intended to limit the implementation of the present application. Rather, example method 200, may illustrate functional information to design/fabricate circuits, generate machine-readable instructions, or use a combination of hardware and machine-readable instructions to perform the illustrated processes. The process of power optimization in cloud computing environment is explained in more detail with reference to FIG. 1.

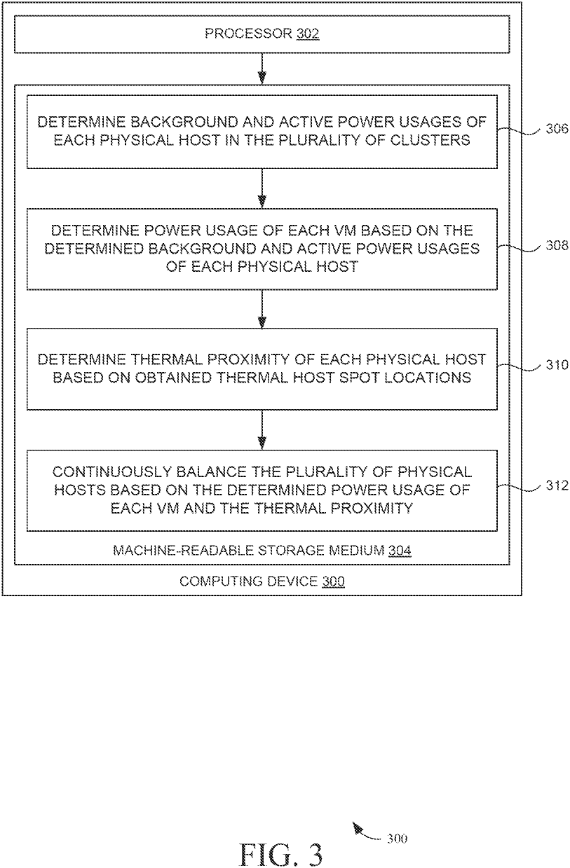

FIG. 3 is a block diagram of an example computing device 300 including a non-transitory machine-readable storage medium on which is stored instructions for power optimization in a cloud computing environment. In an example, computing device 300 may include a virtualization layer that supports execution of the power optimization in the cloud computing environment.

Further, computing device 300 may include a processor 302 and machine-readable storage medium 304 communicatively coupled through a system bus. Processor 302 may be any type of central processing unit (CPU), microprocessor, or processing logic that interprets and executes machine-readable instructions stored in machine-readable storage medium 304. Machine-readable storage medium 304 may be a random-access memory (RAM) or another type of dynamic storage device that may store information and machine-readable instructions for execution by processor 302. For example, machine-readable storage medium 304 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 304 may be a non-transitory machine-readable medium. In an example, machine-readable storage medium 304 may be remote but accessible to computing device 300.

Machine-readable storage medium 304 may store instructions 306-312. In an example, instructions 306-312 may be executed by processor 302 to assist in power optimization in a cloud computing environment. Instructions 306 may be executed by processor 302 to determine background and active power usages of each physical host in plurality of clusters in a power optimization system. Each cluster may include a plurality of physical hosts with at least one virtual machine (VM) running on each physical host.

Instructions 308 may be executed by processor 302 to cause the cloud power optimizer module to determine power usage of each VM running on the plurality of physical hosts based on the determined background and active power usages of each physical host. In an example, instructions 308 may be executed by processor 302 to continuously balance the distribution of workload on the plurality of physical hosts based on the determined power usage of each VM.

Instructions 310 may be executed by processor 302 to cause the cloud power optimizer module to obtain thermal hotspot proximity of each physical host based on received cloud computing environment thermal hotspot location information. For example, the cloud computing environment thermal hotspot location information may be based on a thermal hotspot located at a physical host, a rack, and/or a room level. Instruction 312 may be executed by processor 312 to cause the cloud power optimizer module to continuously balance the distribution of workload on the physical hosts based on the obtained thermal hotspot proximity.

Further, example instructions may be executed by processor 302 to cause the cloud power optimizer module to obtain power profiles of the plurality of physical hosts based on type of physical hosts in each cluster. For example, the type of each physical host may be based on information including older generation, newer generation, power hungry, limited power management capability, advance power management capability, and/or compute per watt usage. Example instructions may further include the plurality of clusters to be labelled based on the obtained power profiles and then to determine a desired power profile of each VM running on each physical host in each cluster based on a resource usage. Example instructions may furthermore include to map the desired power profile of each VM to one of the labelled plurality of clusters and continuously balance the distribution of workload on the plurality of physical hosts based on the mapping.

Furthermore, example instructions may be executed by processor 302 to cause the cloud power optimizer module to receive a call to balance a data set residing in the plurality of storage systems in the power optimization system. Example instructions may further determine whether migration of the data set is to be performed to balance hot data, balance the warm data, and/or re-tier the plurality of storage systems to improve storage efficiency. Also, example instructions may migrate the data set from one storage system to another storage system based on a result of determination in combination with the determined power usage, physical location of the physical hosts, and/or background power usage of the physical hosts.

In addition, example instructions may be executed by processor 302 to cause the cloud power optimizer module to cause the cloud power optimizer module to further continuously rebalances the distribution of workload on the plurality of physical hosts such that a power utilization of a physical host is substantially within a high efficiency band of power supply unit in the physical host. Also, example instructions may be executed by processor 302 to cause the cloud power optimizer module to cause the cloud power optimizer module to further obtain utility rate structures.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A power optimization system comprising:
a cloud management server coupled to a plurality of clusters via a network, wherein each cluster has a plurality of physical hosts with at least one virtual machine (VM) running on each physical host;
a resource management module residing in the cloud management server; and
a cloud power optimizer module residing in the resource management module, wherein the cloud power optimizer module is to:
determine background and active power usages of each physical host in the plurality of clusters;
determine power usage of each VM based on the determined background and active power usages of each physical host; and
continuously balance a distribution of workload on the plurality of physical hosts based on the determined power usage of each VM.

2. The system of claim 1, wherein the cloud power optimizer module further obtains thermal hotspot proximity of each physical host based on received cloud computing environment thermal hotspot location information, and wherein the cloud computing environment thermal hotspot location information is based on a thermal hotspot located on at a physical host, a rack and/or a room level, and wherein the cloud power optimizer module further continuously balances the distribution of workload on the physical hosts based on the determined thermal hotspot proximity.

3. The system of claim 1, wherein the cloud power optimizer module is to further:
obtain power profiles of the plurality of physical hosts based on a type of each physical host in each cluster, and wherein the type of each physical host is based on information including older generation, newer generation, power hungry, limited power management capability, advance power management capability, and/or compute per watt usage;
label the plurality of clusters based on the obtained power profiles;
determine a desired power profile of each VM running on each physical host in each cluster based on a resource usage;
map the desired power profile of each VM to one of the labeled plurality of clusters; and
continuously balance a distribution of workload on the plurality of physical hosts based on the mapping.

4. The system of claim 3, wherein the cloud power optimizer module determines the active power usage of each physical host in the cloud computing environment based on the background power usage associated with each physical host, obtained utilization statistics at VM level of sub-systems in each physical host, and/or power usage requirement of each VM associated with the physical host, and wherein the sub-system is a graphics processing unit (GPU), central processing unit (CPU), memory, and/or field programmable gate array (FPGA).

5. The system of claim 3, wherein the cloud power optimizer module further obtains utility rate structures, wherein the utility rate structures comprise time-based tariffs, demand-based tariffs, and/or usage-based tariffs, and the cloud power optimizer module then continuously balances the distribution of workload on the plurality of physical hosts based on the mapping and the obtained utility rate structures.

6. The system of claim 1, wherein the cloud power optimizer module continuously balances the distribution of workload on physical hosts based on performance and/or power profiles of the plurality of clusters.

7. The system of claim 1, further comprising:
a plurality of storage systems that are communicatively coupled to the plurality of clusters, wherein each storage system includes data sets, and wherein the cloud power optimizer module further to:
receive a call to balance a data set residing in the plurality of storage systems;
determine whether migration of the data set is to be performed to balance hot data, balance the warm data, and/or re-tier the plurality of storage systems to improve storage efficiency; and
migrate the data set from one storage system to another storage system based on a result of determination of whether the migration of the data set is to be performed to balance hot data, balance the warm data, and/or re-tier the plurality of storage systems in combination with the determined power usage, physical location, and/or background power usage of the physical hosts.

8. The system of claim 1, wherein the cloud power optimizer module further continuously rebalances the distribution of workload on the plurality of physical hosts such that a power utilization of a physical host is within a high efficiency band of a power supply unit in the physical host, wherein the high efficiency band is based on a power supply efficiency curve associated with the power supply unit in the physical host.

9. A non-transitory computer-readable storage medium storing instructions executable by a computing device having a cloud power optimizer module in a cloud computing environment, to cause the cloud power optimizer module to:
determine background and active power usages of each physical host in a plurality of clusters in a power optimization system, wherein each cluster has a plurality of physical hosts with at least one virtual machine (VM) running on each physical host;
determine power usage of each VM running on the plurality of physical hosts based on the determined background and active power usages of each physical host; and
continuously balance a distribution of workload on the plurality of physical hosts based on the determined power usage of each VM.

10. The non-transitory computer-readable storage medium of claim 9, further comprising instructions executable by the computing device to cause the cloud power optimizer module to obtain thermal hotspot proximity of each physical host based on received cloud computing environment thermal hotspot location information, and wherein the cloud computing environment thermal hotspot location information is based on a thermal hotspot located at a physical host, a rack and/or a room level, and wherein the cloud power optimizer module further to continuously balance the distribution of workload on the physical hosts based on the obtained thermal hotspot proximity.

11. The non-transitory computer-readable storage medium of claim 9, further comprising instructions executable by the computing device to cause the cloud power optimizer module to:
obtain power profiles of the plurality of physical hosts based on a type of physical hosts in each cluster, and wherein the type of each physical host is based on older generation, newer generation, power hungry, limited power management capability, advance power management capability, and/or compute per watt usage;
label the plurality of clusters based on the obtained power profiles;
determine a desired power profile of each VM running on each physical host in each cluster based on a resource usage;
map the desired power profile of each VM to one of the labeled plurality of clusters; and
continuously balance the distribution of workload on the plurality of physical hosts based on the mapping.

12. The non-transitory computer-readable storage medium of claim 9, further comprising instructions executable by the computing device to cause the cloud power optimizer module to:
receive a call to balance a data set residing in the plurality of storage systems in the power optimization system;
determine whether migration of the data set is to be performed to balance hot data, balance the warm data, and/or re-tier the plurality of storage systems to improve storage efficiency; and
migrate the data set from one storage system to another storage system based on a result of determination of whether the migration of the data set is to be performed to balance hot data, balance the warm data, and/or re-tier the plurality of storage systems in combination with the determined power usage, physical location, and/or background power usage of the physical hosts.

13. The non-transitory computer-readable storage medium of claim 9, wherein instructions to cause the cloud power optimizer module to further continuously rebalance the distribution of workload on the plurality of physical hosts such that a power utilization of a physical host is substantially within a high efficiency band of a power supply unit in the physical host, wherein the high efficiency band is based on a power supply efficiency curve associated with the power supply unit in the physical host.

14. The non-transitory computer-readable storage medium of claim 9, further comprising instructions to cause the cloud power optimizer module to further obtain utility rate structures, wherein the utility rate structures comprise time-based tariffs, demand-based tariffs, and/or usage-based tariffs, and the cloud power optimizer module then continuously balances the distribution of workload on the plurality of physical hosts based on the mapping and the obtained utility rate structures.

15. A method for power optimization based on workload placement in a cloud computing environment, the method comprising:
determining background and active power usages of each physical host in a plurality of clusters, wherein each cluster has a plurality of physical hosts with at least one virtual machine (VM) running on each physical host;
determining power usage of each VM based on the determined background and active power usages of each physical host; and
continuously balancing the distribution of workload on the plurality of physical hosts based on the determined power usage of each VM.

16. The method of claim 15, further comprising:
obtaining thermal hot spot locations in the cloud computing environment;
determining thermal hotspot proximity of each physical host based on obtained thermal hot spot locations in the cloud computing environment; and
continuously balancing the distribution of workload on the plurality of physical hosts based on the determined power usage of each VM and the determined thermal hotspot proximity of each physical host.

17. The method of claim 15, further comprising:
obtaining power profiles of the plurality of physical hosts based on a type of each physical host in each cluster, and wherein the type of each physical host is based on older generation, newer generation, power hungry, limited power management capabilities, advance power management capabilities, and/or compute power per watt usage;
labeling each cluster based on the obtained power profiles;
determining a desired power profile of each VM running in each physical host in each cluster based on a resource usage;
mapping the determined desired power profile of each VM to one of the labeled plurality of clusters; and
continuously balancing the distribution of workload on the plurality of physical hosts in the plurality of clusters based on the mapping.

18. The method of claim 17, further comprising:
obtaining utility rate structures, wherein the utility rate structures comprise time-based tariffs, demand-based tariffs, and/or usage-based tariffs; and
continuously balancing the distribution of workload on the plurality of physical hosts running in the cluster based on the mapping and the determined utility rate structures.

19. The method of claim 15, further comprising:
receiving a call to balance a data set residing in one of a plurality of storage systems that are communicatively coupled to the plurality of clusters in the cloud computing environment;
determine whether migration of the data set is to be performed to balance hot data, balance the warm data, and/or re-tier the plurality of storage systems to improve storage efficiency; and
migrate the data set from one storage system to another storage system based on a result of determination of whether the migration of the data set is to be performed to balance hot data, balance the warm data, and/or re-tier the plurality of storage systems in combination with the determined power usage, physical location of the physical hosts, and/or background power usage of the physical hosts.

20. The method of claim 15, further comprising:
continuously balancing the distribution of workload on the plurality of physical hosts based on performance and/or power profiles of the plurality of clusters.

21. The method of claim 15, further comprising:
obtaining power supply efficiency curve of a power supply unit in each physical host; and
continuously balancing the distribution of workload on the plurality of physical hosts such that a power utilization of each physical host is substantially within a high efficiency band of the power supply unit, wherein the high efficiency band is based on the obtained power supply efficiency curve.
